(19) United States
(12) Patent Application Publication
(10) Pub. No.: US 2007/0119917 A1
(43) Pub. Date: May 31, 2007

(54) Integrated circuit card, mobile communication terminal device, transaction system, and unauthorized use preventing method

(75) Inventors: Tadato Tomikawa, Kawasaki (JP); Kiyotaka Sawae, Kawasaki (JP); Shinichi Matsuya, Kawasaki (JP); Hiroshi Watanabe, Kawasaki (JP); Yoshimitsu Kikuchi, Kawasaki (JP); Yoshikatsu Kimura, Kawasaki (JP); Wataru Miyauchi, Kawasaki (JP); Atsushi Shibayama, Kawasaki (JP); Takahisa Ishikawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/363,211

(22) Filed: Feb. 28, 2006

(30) Foreign Application Priority Data
Nov. 25, 2005 (JP) 2005-340930

(51) Int. Cl. G06K 5/00; G06K 19/06

(52) U.S. Cl. 235/380; 235/492

(57) ABSTRACT

An Integrated Circuit (IC) card stores therein card identification. The IC card includes a verification data fetching unit that fetches verification data from a mobile communication terminal of a user; a verification process unit that verifies whether fetched verification data is authentic thereby verifying whether the user is an authorized user of the IC card; and a controller that permits exchange of the card identification data between the IC card and the transaction terminal upon the verification process unit confirming that the user is an authorized user thereby permitting execution of a transaction process at the transaction terminal.

### BACKGROUND OF THE INVENTION

1. Field of the Invention

The present invention relates to a technology for preventing unauthorized use of an integrated circuit card even if the integrated circuit card and its password are leaked.

2. Description of the Related Art

Cards such as credit cards or cash cards etc. are used to perform financial transactions. Such a card stores therein a card number. When carrying out a transaction with a card, a transaction terminal device or an Automatic Teller Machine (ATM) reads the card number from the card and determines whether the user is authentic based on the read card number and a password supplied by the user. Recently, Integrated Circuit (IC) chip embedded IC cards are increasingly used for financial transactions, and transaction terminal devices or ATMs are configured to read card numbers stored in IC chips of the IC cards.

The IC cards have an advantage that there use is not limited to use for financial transactions. The IC cards for financial transactions can be used for other purposes. For example, mobile phones that can read IC cards have been developed. For example, Japanese Patent Laid-Open Publication Nos. 2004-287593 and 2003-157239 disclose mobile phones that can read card numbers stored in credit cards that are IC cards.

However, if a conventional IC card and its password falls into hands of a fraudulent person, he can perform an unauthorized transaction process or bank transaction. Thus, the conventional IC cards are not very secure.

### SUMMARY OF THE INVENTION

It is an object of the present invention to at least solve the problems in the conventional technology.

According to an aspect of the present invention, an Integrated Circuit (IC) card that stores therein card identification data that is used to identify the IC card at a transaction terminal includes a verification data fetching unit that fetches verification data from a mobile communication terminal of a user; a verification process unit that verifies whether fetched verification data is authentic thereby verifying whether the user is an authorized user of the IC card; and a controller that permits exchange of the card identification data between the IC card and the transaction terminal upon the verification process unit confirming that the user is an authorized user, and the prohibits exchange of the card identification data between the IC card and the transaction terminal upon the verification process unit confirming that the user is not an authorized user.

According to another aspect of the present invention, a mobile communication terminal device having an arrangement communicating with an Integrated Circuit (IC) card that stores therein card identification data that is used to identify the IC card at a transaction terminal, includes a storage unit that stores therein device identification data; and a verification data generating unit that generates verification data based on the device identification data and causes the arrangement to send the verification data to the IC card.

According to still another aspect of the present invention, a transaction system includes a mobile communication terminal that includes a first storage unit that stores therein device identification data; and a verification data generating unit that generates verification data based on the device identification data; an Integrated Circuit (IC) card that includes a second storage unit that stores therein card identification data; a verification data fetching unit that fetches the verification data from the mobile communication terminal; a verification process unit that verifies whether fetched verification data is authentic thereby verifying whether a user of the mobile communication terminal is an authorized user of the IC card; and a controller that permits exchange of the card identification data between the IC card and a transaction terminal upon the verification process unit confirming that the user is an authorized user, and the prohibits exchange of the card identification data between the IC card and the transaction terminal upon the verification process unit confirming that the user is not an authorized user; and the transaction terminal that carries out a transaction process upon receiving the card identification data from the IC card.

According to still another aspect of the present invention, a method of authenticating a user of an Integrated Circuit (IC) card before allowing the user to perform a transaction process with the IC card includes sending a fetch request from the IC card to a digital device of the user; sending verification data from the digital device to the IC card upon receiving the fetch request; determining whether the verification data is authentic based on received verification thereby confirming whether the user is an authorized user of the IC card; and sending card identification data from the IC card to a transaction terminal that performs the transaction process upon determining at the determining that the user is an authorized user.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an IC-card unauthorized-use preventing system according to an embodiment of the present invention;

FIG. 2 is a functional block diagram of a mobile phone shown in FIG. 1;

FIG. 3 is a schematic of an IC card shown in FIG. 1;

FIG. 4 is a functional block diagram of an IC chip shown in FIG. 1;

FIG. 5 is a flow chart of a processing procedure performed by the IC-card unauthorized-use preventing system shown in FIG. 1; and

FIG. 6 is a flow chart of a processing procedure performed by the IC-card unauthorized-use preventing system shown in FIG. 1.

### DETAILED DESCRIPTION OF THE PREFERRED EMBODIMENTS

Exemplary embodiments of the present invention are explained next in detail with reference to the accompanying drawings. The present invention applied to an IC card (cash card) that is used for a bank transaction is explained in an embodiment.

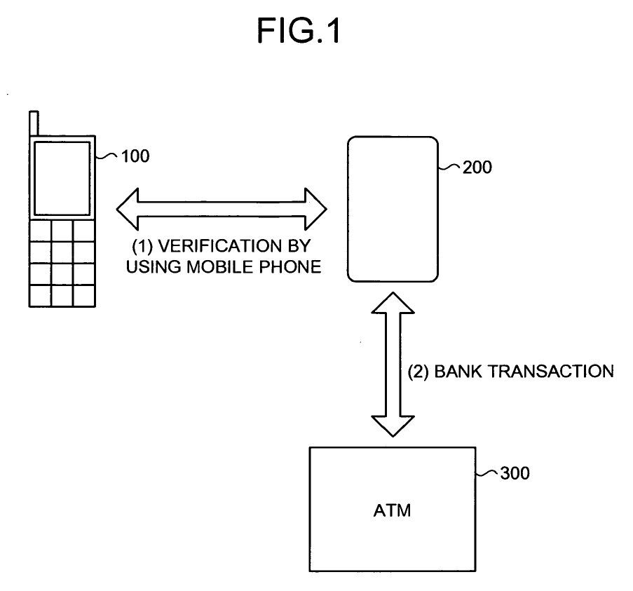

FIG. 1 is a schematic of an IC-card unauthorized-use preventing system according to an embodiment of the present invention. The IC-card unauthorized-use preventing system includes a mobile phone 100, an IC card 200, and an Automatic Teller Machine (ATM) 300. In the IC-card unauthorized-use preventing system, before using an IC card 200, a communication is carried out between the IC card 200 and a mobile phone 100 at step (1) to carry out user verification, and after verifying that the user is an authorized user, the bank transaction using the IC card 200 is enabled at step (2). The step (1) and step (2) are the salient features of the IC-card unauthorized-use preventing system.

Conventionally, when carrying out the, bank transaction, user verification is carried out based on insertion of the IC card 200 by the user into the Automatic Teller Machine (ATM) 300 that is installed in the bank and input of a password into the ATM 300 by the user. However, sufficient security cannot be secured by using only the password that usually includes four digits. Especially, if the password is leaked, an unauthorized user can also carry out the bank transaction similarly as the authorized user. In the present embodiment, by focusing on uniqueness of the mobile phone 100 that is possessed by the user, the user verification is carried out based on a unique data that is stored in the mobile phone 100. The bank transaction is enabled only if the user verification is satisfactory.

The IC card 200 is a noncontact IC card that operates by using as,power source electromagnetic waves that are received by an internal antenna. The IC card 200 becomes operable when brought near the ATM 300, fetches verification data from the mobile phone 100 to carry out the user verification, and carries out a transaction process with the ATM 300 after the user verification is completed.

A unique manufacturing code and subscriber data are stored inside the mobile phone 100. Based on the manufacturing code and the subscriber data, the mobile phone 100 generates the verification data and provides the verification data to the IC card 200. The mobile phone 100 includes a function to carry out a noncontact data transfer with the IC card 200 apart from the original wireless communication function. Any method can be used as a communication method between the mobile phone 100 and the IC card 200.

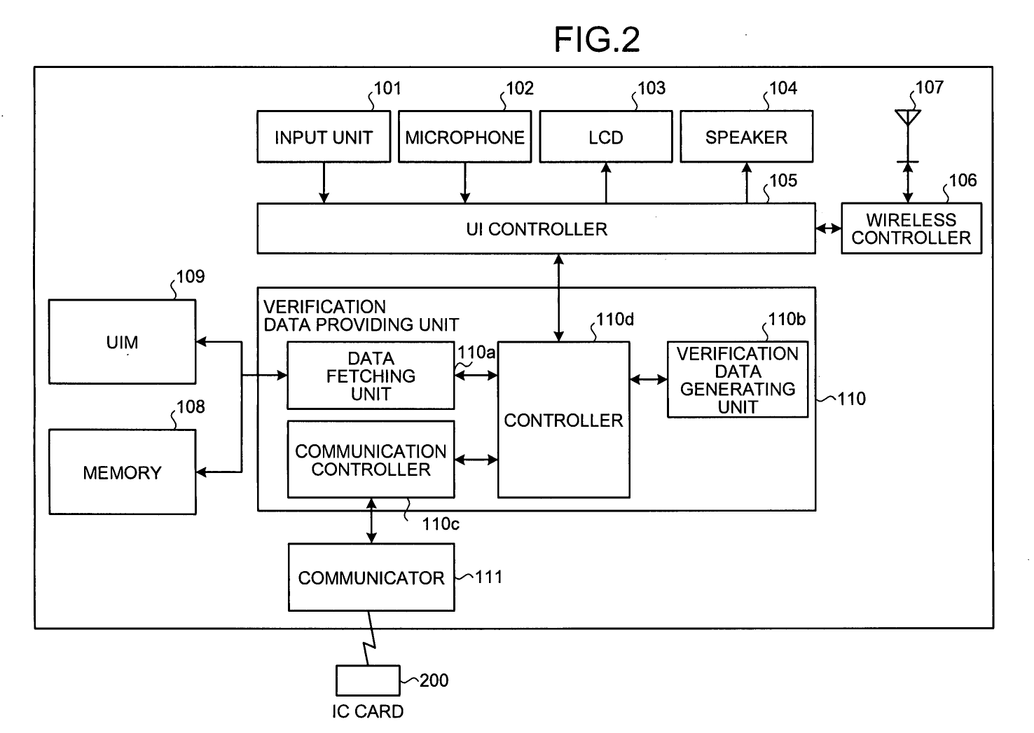

FIG. 2 is a functional block diagram of the mobile phone 100. The mobile phone 100 includes an input unit 101, a microphone 102, a Liquid Crystal Display (LCD) 103, a speaker 104, a User Interface (UI) controller 105, a wireless controller 106, an antenna 107, a memory 108, a User Identify Module (UIM) 109, a verification data providing unit 110, and a communicator 111.

The input unit 101 is an input device that receives input of numerals, characters, symbols etc. The microphone 102 is an input device for inputting a call sound. The LCD 103 is a display device that displays various types of data related to communication. The speaker 104 is an output device that outputs receiving sound. The UI controller 105 controls various input output devices (the input unit 101, the microphone 102, the LCD 103, and the speaker 104) related to a user interface.

The wireless controller 106 carries out communication control pertaining to wireless communication such as outgoing call control and incoming call control. The antenna 107 transmits electromagnetic waves to a mobile phone base station and receives electromagnetic waves from the mobile phone base station.

The memory 108 stores device identification data such as the manufacturing code of the mobile phone 100 etc. The memory 108 is not rewriteable. The UIM 109 is a nonvolatile storage device that stores the subscriber data that is issued by the mobile phone company. The UIM 109 is detachable from the main body of the mobile phone 100.

The verification data providing unit 110 generates the verification data that is required when carrying out the user verification by using the IC card 200 and provides the generated verification data to the IC card 200. The UIM 109 includes a data fetching unit 110a, a verification data generating unit 110b, a communication controller 110c, and a controller 110d.

The data fetching unit 110a responds to an instruction from the controller 110d, reads the device identification data and the subscriber data from the memory 108 and the UIM 109 respectively, and outputs the read data to the controller 110d. The controller 110d, upon receiving a request pertaining to the verification data from the IC card 200, issues a read data instruction to the data fetching unit 110a.

By using as input the device identification data and the subscriber data that are fetched by the data fetching unit 110a, the verification data generating unit 110b executes a predetermined algorithm to generate the verification data. A one way hash function can be used as the algorithm. In the present embodiment, the verification data is generated from the device identification data and the subscriber data. However, the device identification data (the manufacturing code) that randomly specifies the mobile phone 100 can also be used as the verification data.

The communication controller 110c uses the communicator 111 to exercise control pertaining to noncontact communication with the IC card 200. For example, if the IC card 200 is a noncontact IC card of proximity type (within 70 cm) that is regulated by ISO15693, apart from including the communicator 111 that is communicable with the noncontact IC card, the communication controller 110c exercises communication control by using a protocol that is compatible with the noncontact communicating method. If the IC card 200 includes an infrared communication function, the communication controller 110c provides the infrared communication function in the communicator 111.

The controller 110d exercises complete control over the verification data providing unit 110. To be specific, upon receiving a request pertaining to the verification data from the IC card 200, the controller 110d issues a fetch data instruction to the data fetching unit 110a, outputs the fetched data to the verification data generating unit 110b, and issues a generate verification data instruction. Upon receiving the verification data, the controller 110d transfers the verification data to the communication controller 110c and exercises control such that the verification data is transmitted to the IC card 200.

Using the mobile phone 100 having the aforementioned structure not only enables communication with the mobile phone base station, but also enables to generate the verification data based on the device identification data in response to a request from the IC card 200, and to provide the verification data to the IC card 200.

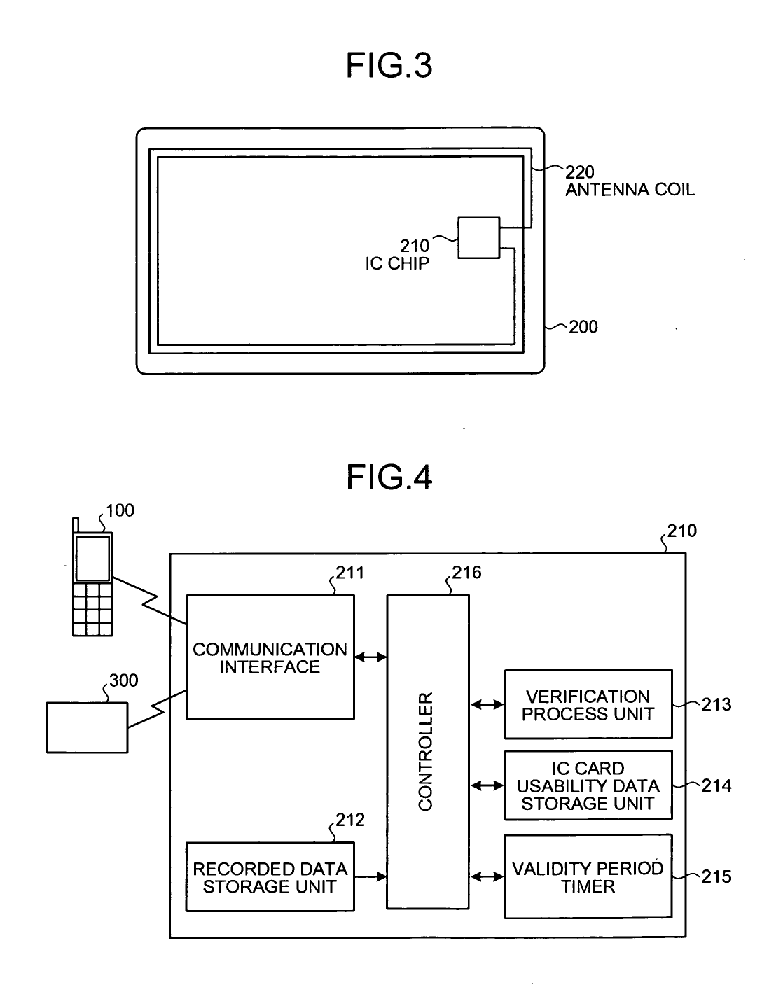

FIG. 3 is a schematic of the IC card 200 and FIG. 4 is a functional block diagram of an IC chip 210 shown in FIG. 3. The IC card 200 includes the IC chip 210 and an antenna coil 220 that are provided on a card shaped plastic. The IC card 200 operates while charging itself using the electromagnetic waves from the ATM 300 as a power source. Although the IC chip 210 and the antenna coil 220 are elicited for the sake of convenience, the surface of the IC chip 210 and the antenna coil 220 is covered with a resin sheet.

As shown in FIG. 4, the IC chip 210 includes a communication interface 211, a recorded data storage unit 212, a verification process unit 213, an IC card usability data storage unit 214, a validity period timer 215, and a controller 216.

The communication interface 211 is an interface for carrying out data communication with the mobile phone 100 or the ATM 300 using a communication method pertaining to the noncontact IC card. When carrying out communication with the mobile phone 100 using the infrared communication method etc., the communication interface 211 needs to be compatible with both the communication method pertaining to the noncontact IC card and the infrared communication method.

The recorded data storage unit 212 is a storage device, which stores as recorded data the subscriber data of the authorized user and the device identification data of the mobile phone 100 that is possessed by the authorized user. The verification process unit 213 compares the device identification data and the subscriber data that are included in the verification data received from the mobile phone 100 with the device identification data and the subscriber data that are stored in the recorded data storage unit 212 respectively, and carries out the verification process to determine whether the user is the authorized user.

The IC card usability data storage unit 214 is a storage device, which stores a usability flag that indicates whether the IC card 200 is usable in the ATM 300. If the verification process unit 213 determines that the user is the authorized user, the usability flag is set to “1 (on)” that indicates “use permitted”. If the verification process unit 213 determines that the user is an unauthorized user, the usability flag is set to “0 (off)” that indicates “use prohibited”.

The validity period timer 215 times a validity period of the usability flag that is stored in the IC card usability data storage unit 214. The validity period timer 215 starts timing when the usability flag is updated to “1”. If the validity period timer 215 has timed the usability flag for a predetermined time period (for example, 5 minutes), the controller 216 updates the usability flag to “0”. Even if the verification process unit 213 verifies that the user is the authorized user, the usability flag is cleared after the predetermined time to ensure that the user is not identified as the authorized user for a prolonged time period.

The controller 216 exercises complete control over the IC card 200. To be specific, the controller 216 controls communication with the mobile phone 100 and the ATM 300 via the communication interface 211, controls reading and writing of data pertaining to the recorded data storage unit 212 and the IC card usability data storage unit 214, issues a verify instruction to the verification process unit 213, and issues start timing, end timing, and initialize instructions to the validity period timer 215.

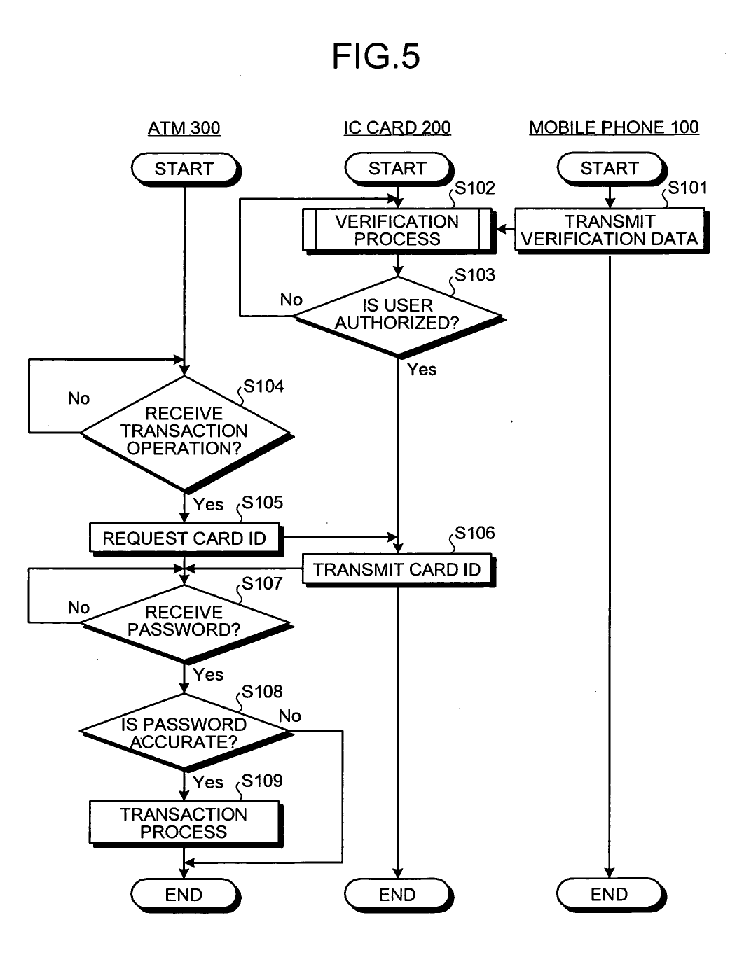

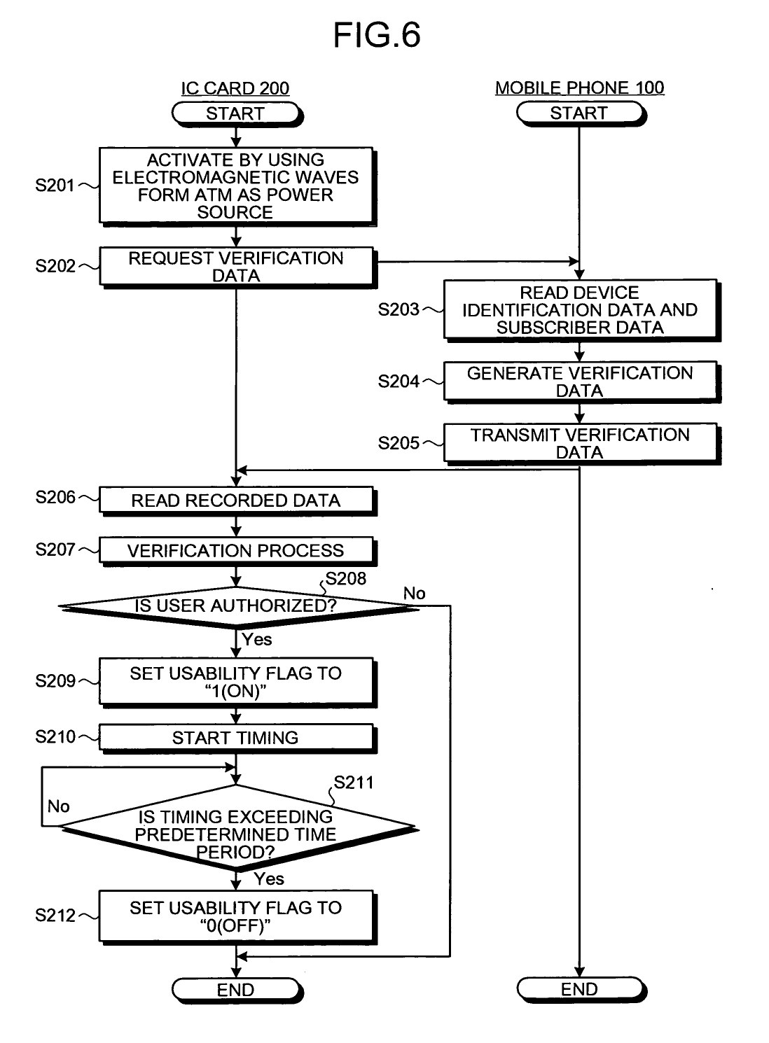

FIG. 5 is a flow chart of the sequence of the transaction process by using the IC card 200 shown in FIG. 1. As shown in FIG. 5, before carrying out the transaction with the ATM 300, the IC card 200 carries out the verification process based on the verification data from the mobile phone 100. To be specific, the mobile phone 100 transmits the verification data to the IC card 200 (step S101), and based on the verification data the IC card 200 carries out the verification process (step S102). The verification process is explained in detail later with reference to FIG. 6.

Based on a result of the verification process, if the user is verified as an unauthorized user (“No” at step S103), the bank transaction with the ATM 300 is disabled. The IC card 200 further continues the verification process, and carries out an error process if verification is not successful.

If the user is verified as the authorized user (“Yes” at step S103), the transaction process with the ATM is enabled. To be specific, upon carrying out a predetermined transaction operation on the ATM 300 (selection of withdrawal from an account) (“Yes” at step S104), the ATM 300 issues a request pertaining to the card ID to the IC card 200 (step S105). The IC card 200 responds to the request and returns the card ID (step S106).

Next, the ATM 300 receives an input of the password (“Yes” at step S107), and if the password is accurate (step S108), executes the transaction process (step S109).

Thus, in the IC-card unauthorized-use preventing system according to the present embodiment, the bank transaction via the ATM 300 cannot be carried out without bringing the mobile phone 100 that is possessed by the authorized user of the IC card 200 even if the IC card 200 is valid. Such a precaution is taken to ensure that an unauthorized user is not able to carry out an unauthorized bank transaction even if the unauthorized user fraudulently uses the IC card 200 and the password.

Although the ATM 300 receives the password, because the user verification is carried out by using the mobile phone 100, a necessity to input the password can be removed.

Next, the verification process shown at step S102 of FIG. 5 is explained in detail. FIG. 6 is a flow chart of a sequence of the verification process shown at step S102 of FIG. 5. As shown in FIG. 6, if the user comes near the ATM 300, the IC card 200 that is possessed by the user uses the electromagnetic waves of the ATM 300 as power source to activate itself (step S201), and issues a request pertaining to the verification data to the mobile phone 100 (step S202).

Upon receiving the verification data request, the mobile phone 100 reads the device identification data from the memory 108 and reads the subscriber data from the UIM 109 (step S203). Based on the device identification data and the subscriber,data, the mobile phone 100 generates the verification data (step S204), and returns the generated verification data to the IC card 200 (step S205).

Upon receiving the verification data, the IC card 200 reads the recorded data (the device identification data and the subscriber data) that is stored in the recorded data storage unit 212 (step S206), and carries out the verification process by comparing the recorded data and the received verification data (step S207). To be specific, the IC card 200 generates the verification data for comparison from the device identification data and the subscriber data that are included in the recorded data, and carries out the verification process by comparing the generated verification data with the verification data received from the mobile phone 100.

Based on the result of the verification process, if the user is verified as the authorized user (step S208), the IC card 200 sets the usability flag that is stored in the IC card usability data storage unit 214 to “1” (step S209). The bank transaction with the ATM 300 is enabled if the usability flag is set to “1”. However, if the user is verified as an unauthorized user (“No” at step S208), the usability flag remains at “0”.

When the usability flag is set to “1”, the validity period timer 215 starts timing (step S210). If the timing exceeds a predetermined time period (“Yes” at step S211), the usability flag is set to “0”. Due to this, the time period during which the IC card 200 is verified as valid is reduced to a minimum necessary time period, and use of the IC card 200 is disabled after completion of the transaction.

In the present embodiment, before carrying out the bank transaction using the IC card 200, the verification process using the mobile phone 100 is carried out, and the bank transaction with the ATM 300 by using the IC card 200 is enabled only if the user is verified as the authorized user, thereby enabling to prevent unauthorized card use even if the IC card 200 and the password are leaked to the unauthorized user, and enabling to prevent occurrence of unforeseen disadvantage to the authorized card holder.

The present invention applied to the IC card (cash card) that is used for a bank transaction is explained in the present embodiment. However, the present invention is not to be limited and can also be applied to various types of IC cards such as the credit cards that are used in credit card transactions and rely on the password for security.

In the present embodiment, the IC card 200 requests the verification data from the mobile phone 100. However, the present invention is not to be thus limited, and the verification data can also be transmitted to the IC card 200 upon receiving an input operation on the mobile phone 100.

In the present embodiment, the verification data is generated based on the device identification data and the subscriber data pertaining to the mobile phone 100. However, the present invention is not to be thus limited, and the device identification data itself can also be transmitted as the verification data. Further, the verification data can also be generated based on the device identification data and time data, and the generated verification data can be used as a unique value to further prevent unauthorized use.

According to the present invention, an Integrated Circuit (IC) card includes a verification data fetching unit that fetches verification data from a mobile communication terminal that is possessed by a user of the IC card, a verification process unit that verifies, based on the verification data that is fetched by the verification data fetching unit, whether the user is an authorized user of the IC card, and a controller that permits a transaction by a transaction terminal if the user is verified as the authorized user by the verification process unit and prohibits the transaction by the transaction terminal if the user is verified as an unauthorized user by the verification process unit, thereby enabling to prevent unauthorized use of the IC card by the unauthorized user even if the password is leaked.

According to the present invention, a storage unit is further included that stores device identification data pertaining to the mobile communication terminal, the verification data fetching unit fetches from the mobile communication terminal, the verification data that includes the device identification data pertaining to the mobile communication terminal, and based on the verification data that is fetched by the verification data fetching unit and the device identification data that is pertaining to the mobile communication terminal and stored in the storage unit, the verification process unit verifies whether the user is the authorized user of the IC card, thereby enabling to accurately confirm, based on possession of the unique mobile communication terminal due to the device identification data, that the user of the IC card is the authorized user. Especially, both the mobile communication terminal and the IC card are possessed by the user and are used to carry out user verification, thereby enabling to enhance accuracy pertaining to verification.

According to the present invention, a mobile communication terminal device that includes the IC card further includes a verification data storage unit that stores the verification data that is transferred to the IC card before transferring the card identification data to the transaction terminal, a verification data fetching unit that fetches the verification data from the verification data storage unit, a verification process unit that verifies, based on the verification data fetched by the verification data fetching unit, whether the user of the IC card is the authorized user, and a controller that permits, a transaction by the transaction terminal if the user is verified as the authorized user by the verification process unit and prohibits the transaction by the transaction terminal if the user is verified as an unauthorized user, thereby enabling to carry out verification pertaining to the user of the IC card by using the mobile communication terminal device, and enabling to enhance convenience and accuracy pertaining to verification.

According to the present invention, the mobile communication terminal includes a communicator that communicates with the IC card, the storage unit that stores the device identification data that is unique to the mobile communication terminal device, and the verification data generating unit that generates the verification data based on the device identification data that is stored in the storage unit, and the IC card includes a verification data requesting unit that requests the mobile communication terminal for the verification data before transferring the card identification data to the transaction terminal, the verification process unit that verifies, based on the verification data that is received from the mobile communication terminal, whether the user is the authorized user of the IC card, and the controller that permits a transaction by the transaction terminal if the user is verified as the authorized user by the verification process unit and prohibits the transaction by the transaction terminal if the user is verified as an unauthorized user by the verification process unit. Thus, verification pertaining to the user of the IC card can be carried out only by using a combination of the unique mobile communication terminal and the IC card, thereby enabling to carry out user verification accurately.

According to the present invention, a verification data fetching process fetches, before transferring the card identification data to the transaction terminal, the verification data from the mobile communication terminal that is possessed by the user of the IC card, a verification process verifies, based on the verification data that is fetched by the verification data fetching process, whether the user is the authorized user of the IC card, and a control process permits a transaction by the transaction terminal if the user is verified as the authorized user by the verification process and prohibits the transaction by the transaction terminal if the user is verified as an unauthorized user by the verification process. Thus, verification pertaining to the user of the IC card can be carried out only by using a combination of processes in the unique mobile communication terminal and processes in the IC card, thereby enabling to carry out user verification accurately.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An Integrated Circuit (IC) card that stores therein card identification data that is used to identify the IC card at a transaction terminal, the IC card comprising:
a verification data fetching unit that fetches verification data from a mobile communication terminal of a user;
a verification process unit that verifies whether fetched verification data is authentic thereby verifying whether the user is an authorized user of the IC card; and
a controller that permits exchange of the card identification data between the IC card and the transaction terminal upon the verification process unit confirming that the user is an authorized user, and the prohibits exchange of the card identification data between the IC card and the transaction terminal upon the verification process unit confirming that the user is not an authorized user.

2. The IC card according to claim 1, further comprising a storage unit that stores therein first device identification data, wherein
the verification data fetching unit fetches second device identification data from the mobile communication, and
the verification process unit confirms that the second device verification data is authentic when the second device verification data matches with the first device verification data.

3. The IC card according to claim 1, wherein the verification process unit sets a usability flag to a valid state upon confirming that the user is an authorized user, and the controller permits exchange of the card identification data between the IC card and when the usability flag is in the valid state.

4. The IC card according to claim 3, further comprising:
a timer that starts counting time from a time point when the usability flag is set in the valid state, wherein
the verification process unit turns the usability flag into an invalid state upon the time counted by the timer reaching a certain value.

5. The IC card according to claim 1, further comprising a power source that receives power in the form of electromagnetic waves from the transaction terminal, wherein
the verification data fetching unit requests, upon the power source being acted by receiving power from the transaction terminal, the mobile communication terminal for the verification data.

6. The IC card according to claim 1, wherein the verification data fetching unit fetches, by using the same communication method as a communication method with the transaction terminal, the verification data from the mobile communication terminal.

7. A mobile communication terminal device having an arrangement communicating with an Integrated Circuit (IC) card that stores therein card identification data that is used to identify the IC card at a transaction terminal, comprising:
a storage unit that stores therein device identification data; and
a verification data generating unit that generates verification data based on the device identification data and causes the arrangement to send the verification data to the IC card.

8. A transaction system comprising:
a mobile communication terminal that includes
a first storage unit that stores therein device identification data; and
a verification data generating unit that generates verification data based on the device identification data;
an Integrated Circuit (IC) card that includes
a second storage unit that stores therein card identification data;
a verification data fetching unit that fetches the verification data from the mobile communication terminal;
a verification process unit that verifies whether fetched verification data is authentic thereby verifying whether a user of the mobile communication terminal is an authorized user of the IC card; and
a controller that permits exchange of the card identification data between the IC card and a transaction terminal upon the verification process unit confirming that the user is an authorized user, and the prohibits exchange of the card identification data between the IC card and the transaction terminal upon the verification process unit confirming that the user is not an authorized user; and
the transaction terminal that carries out a transaction process upon receiving the card identification data from the IC card.

9. A method of authenticating a user of an Integrated Circuit (IC) card before allowing the user to perform a transaction process with the IC card, the method comprising:
sending a fetch request from the IC card to a digital device of the user;
sending verification data from the digital device to the IC card upon receiving the fetch request;
determining whether the verification data is authentic based on received verification thereby confirming whether the user is an authorized user of the IC card; and
sending card identification data from the IC card to a transaction terminal that performs the transaction process upon determining at the determining that the user is an authorized user.
